(19) United States
(12) Patent Application Publication
(10) Pub. No.: US 2012/0270476 A1
(43) Pub. Date: Oct. 25, 2012

(54) Diatomaceous Earth-Containing Slurry Composition And Method For Polishing Organic Polymer-Based Ophthalmic Substrates Using The Same

(75) Inventor: Yue Liu, Pittsford, NY (US)

(73) Assignee: FERRO CORPORATION, Mayfield Heights, OH (US)

(21) Appl. No.: 13/532,838

(22) Filed: Jun. 26, 2012

Related U.S. Application Data
(62) Division of application No. 12/824,280, filed on Jun. 28, 2010.
(60) Provisional application No. 61/221,142, filed on Jun. 29, 2009.

(51) Int. Cl. C09K 3/14; B24B 1/00

(52) U.S. Cl. 451/36

(57) ABSTRACT

The present invention provides a slurry composition and method for polishing organic polymer-based ophthalmic substrates. The slurry composition according to the invention includes an aqueous dispersion of particles of diatomaceous earth and, optionally, particles of abrasives selected from alumina, zirconia, silica, titania and combinations of the foregoing. Slurry compositions according to the invention can be used to polish all types of organic polymer-based ophthalmic substrates, but are particularly useful for polishing organic polymer-based ophthalmic substrates having an index of refraction greater than 1.498 because they remove such materials at a greater efficiency than conventional slurry compositions.

### BACKGROUND OF INVENTION

1. Field of Invention

The present invention relates to a slurry composition and method for polishing organic polymer-based ophthalmic substrates.

2. Description of Related Art

A variety of slurry compositions are known in the art for use in polishing organic polymer-based ophthalmic substrates. Such prior art slurry compositions generally consist of abrasive particles dispersed in deionized water and/or other liquids. Commonly utilized abrasive particles include, for example, cerium oxide, aluminum oxide, zirconium oxide, tin oxide, silicon dioxide and titanium oxide. Aluminum oxide slurry is most commonly used for polishing organic polymer-based ophthalmic substrates such as, for example, allyl diglycol carbonate polymer, which is commonly known in the art as CR-39, and other higher index of refraction polycarbonate resins.

Slurry compositions consisting solely of aluminum oxide abrasive particles dispersed in deionized water produce acceptable surface quality when used to polish organic polymer-based ophthalmic substrates, but exhibit unacceptably low polishing efficiency (i.e., a low removal rate). The polishing efficiency of such slurry compositions can be improved by using significantly larger aluminum oxide particles, but the use of larger particles results in unsatisfactory surface quality (i.e. scratches, pit marks, orange peel or like defects).

Koshiyama et al., U.S. Pat. No. 4,225,349, disclose a polishing composition consisting of calcined alumina (aluminum oxide particles) and an aluminum salt polishing accelerator dispersed in deionized water that accelerates the removal of the CR-39 substrate material without degrading the surface quality. The preferred polishing accelerator identified by Koshiyama et al. is aluminum nitrate.

CR-39, which has an index of refraction of about 1.498, has dominated the market for organic polymer-based ophthalmic substrates for many years. In recent years, however, higher index of refraction organic polymer-based ophthalmic substrates have been developed, and these higher index of refraction substrates are becoming more prevalent in the ophthalmic lens market. The higher index of refraction substrates provide several distinct advantages over CR-39 in ophthalmic lens applications. For example, lenses that are fabricated from 1.586 index of refraction polycarbonate substrates are thinner and lighter in weight than comparable lenses fabricated from CR-39, and further provide improved impact resistance. This makes polycarbonate-based ophthalmic substrates more suitable for use in fabricating eyewear worn by children, active adults and in the production of safety glasses. Generally speaking, the higher the index of refraction, the thinner and lighter the ophthalmic lens. Higher index of refraction organic polymer-based ophthalmic substrates allow for the fabrication of eyewear that is functional and fashionable, and which eliminates the “bulbous” or thick “coke-bottle” look often found with lower index of refraction lenses.

Known slurry compositions for use in polishing CR-39 do not provide the desired polishing efficiency, even when a conventional accelerator such as aluminum nitrate is present. A slurry composition that provides high removal efficiency, particularly on higher index of refraction organic polymer-based ophthalmic substrates, is desired.

### BRIEF SUMMARY OF THE INVENTION

The present invention provides a slurry composition and method for polishing organic polymer-based ophthalmic substrates. The slurry composition and method of the invention polishes high index polymer-based ophthalmic substrates with greater polishing efficiency than can be achieved with conventional slurry compositions. A slurry composition according to the invention comprises an aqueous dispersion of particles of diatomaceous earth and optional additional abrasive particles selected from the group consisting of alumina, zirconia, silica, titania and combinations thereof. Water soluble nitrogen-containing organic polymers such as polyvinylpyrrolidone can also be included in the slurry. Slurry compositions according to the invention have a viscosity of less than about 40 cps and can by processed through conventional lens polishing apparatus.

Slurry compositions according to the invention can be used to polish all types of organic polymer-based ophthalmic substrates, but are particularly useful for polishing organic polymer-based ophthalmic substrates having an index of refraction greater than 1.498 because they remove such materials at a greater efficiency than conventional slurry compositions.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

Throughout the instant specification and in the appended claims, the phrase “organic polymer-based ophthalmic substrates” refers to organic thermosetting or thermoplastic polymer materials used in the fabrication of eyeglass lenses and other optometric devices. Included within this definition are polycarbonate materials such as allyl diglycol carbonate polymers commonly known as CR-39 and other thermosetting and thermoplastic organic polymer resins used to fabricate ophthalmic lenses. Specifically excluded from this definition are inorganic glasses and inorganic crystal based substrates. The phrase “high index organic polymer-based ophthalmic substrates” refers to those organic polymer-based ophthalmic substrates that have an index of refraction greater than 1.498, which is the index of refraction for the allyl diglycol carbonate polymer known in the art as CR-39. Most manufacturers of organic polymer-based ophthalmic substrates regard the specific composition of their ophthalmic substrate materials as proprietary information. Applicants do not have knowledge of the specific compositions of such materials, but generally know that such substrates belong to polymer families such as polycarbonates, polyurethanes, polyesters including polyacrylates and epoxies, polyacrylamides and polysulfones. These organic polymer families may be homopolymers or copolymers, and many are cross-linked and/or co-polymerized with other organic and inorganic compounds. Most are thermocast.

Slurry compositions according to the present invention can be used to polish all organic polymer-based ophthalmic substrates, but are particularly suitable for use in polishing high index organic polymer-based ophthalmic substrates. As shown in the accompanying Examples, slurry compositions according to the invention provide greater polishing efficiency on high index organic polymer-based ophthalmic substrates than convention slurry compositions. Furthermore, slurry compositions according to the invention provide similar, if not improved, polishing efficiencies on traditional polycarbonate materials such as CR-39

Slurry compositions according to the present invention preferably comprise an aqueous dispersion comprising particles of diatomaceous earth. Diatomaceous earth is a naturally occurring sedimentary rock that can be processed into powder form. The material principally consists of fossilized remains of diatoms, which are a type of hard-shelled algae. The material is generally regarded to be a very mild abrasive, and has been used in the past in high viscosity pastes for polishing teeth and metals.

The diatomaceous earth used in the present invention must have a relatively small particle size. In the preferred embodiment, the diatomaceous earth will pass through a 325 mesh sieve with only about 1.5% being retained. The D₅₀ of the material is preferably less than 10 μm (e.g., about 9.2 μm).

The slurry compositions according to the invention can further comprise, in addition to particles of diatomaceous earth, other conventional abrasive particles utilized in polishing high index organic polymer-based ophthalmic substrates. Preferably, such additional conventional abrasive particles are selected from the group consisting of alumina, zirconia, silica, titania and combinations of the foregoing. It will be appreciated that the abrasive particles can be doped with or contain small amounts of other elements. Abrasives are typically produced by high temperature calcination, but can be produced by other methods. Calcined alumina abrasive particles are presently most preferred for use in combination with diatomaceous earth.

The conventional abrasive particles used in the invention preferably have a particle size within the range of from about 0.01 μm to about 4.0 μm, more preferably within the range of from about 0.05 μm to about 2.5 μm, and most preferably within the range of from about 1.0 μm to about 2.5 μm.

The particles of diatomaceous earth and other optional abrasive particles collectively preferably comprise from about 5% to about 40% of the slurry composition by weight, and more preferably within the range of from about 10% to about 30% of the slurry composition by weight. In order to be able to be circulated through conventional lens polishing equipment, the slurry composition must have a viscosity of less than about 200 cP, and more preferably less than about 100 cP.

The slurry compositions according to the invention may further comprise a water soluble nitrogen-containing organic polymer. A preferred water soluble nitrogen-containing organic polymer for use in the invention is polyvinyl pyrrolidone (“PVP”). Preferably, the weight average molecular weight of the PVP used in the slurry composition according to the invention is within the range of from about 3,000 to about 60,000, and more preferably from about 10,000 to about 50,000. PVP with a weight average molecular weight within these ranges is readily available from a variety of chemical suppliers.

Other water soluble nitrogen-containing organic polymers suitable for use in the invention include, for example, N-octyl-2-pyrrolidone, N-dodecyl-2-pyrrolidone, N-methyl-2-pyrrolidone, N-ethyl-2-pyrrolidone, N-hydroxyethyl-2-pyrrolidone, N-cyclohexyl-2-pyrrolidone, N-butyl-2-pyrrolidone, N-hexyl-2-pyrrolidone, N-decyl-2-pyrrolidone, N-octadecyl-2-pyrrolidone, N-hexadecyl-2-pyrrolidone, copolymers of polyvinyl pyrrolidone, polyvinyl caprolactam and combinations of the foregoing. The water soluble nitrogen-containing organic polymer is preferably present in the slurry composition at a loading up to about 5% by weight, and more preferably from about 0.15% to about 4.0% by weight. The effectiveness of the water soluble nitrogen-containing organic polymer in increasing the removal efficiency of high index organic polymer-based ophthalmic substrates is not diminished when conventional accelerators such as aluminum nitrate are also present.

Aluminum nitrate is a known polishing efficiency accelerator for use on 1.498 Index substrates. Aluminum nitrate can be used in slurry compositions according to the invention without adversely degrading the efficiency improvements provided on high index organic polymer-based ophthalmic substrates. When aluminum nitrate is used in a slurry composition according to the invention, it is present in an amount preferably within the range of from about 0.25% to 4.0% by weight, and more preferably from about 0.5% to about 3.0% by weight.

As is well known in the art, colloidal aluminum hydroxide can be used as a suspending agent for alumina abrasive particles. When present, the colloidal aluminum hydroxide comprises from about 0.49% to about 1.47% by weight of the slurry, and more preferably, 0.735% to about 1.225% by weight of the slurry.

Preferably, an anti-foaming agent such as modified siloxane treated fumed silica is also used. Anti-foaming agents of this type are well known in the art, and can be acquired from a variety of vendors. Anti-foaming agents are typically present in an amount from about 0.025% to about 0.30% by weight, and more preferably from about 0.025% to about 0.10% by weight.

It will be appreciated that surfactants, biocides, pH modifiers, pH buffers, rheology modifiers and other compounds can also be present in the slurry composition provided they do not adversely react with the diatomaceous earth and other compounds and thereby adversely affect the efficiency of the polishing slurry, or detrimentally affect the final surface quality produced via polishing.

It will be appreciated that the slurry composition can be shipped and stored in the form of a dry powder or a concentrated aqueous paste, which can be readily dispersed in water with a minimum of mixing in order to prepare an aqueous polishing slurry for polishing organic polymer-based ophthalmic substrates. Thus, the invention further provides a dry powder composition that can be dispersed in water to form an aqueous polishing slurry, and a method of polishing an organic polymer-based ophthalmic substrate comprising dispersing a dry composition comprising diatomaceous earth and other optional abrasive particles selected from the group consisting of alumina, zirconia, silica and titania in water to form an aqueous polishing slurry, disposing the aqueous polishing slurry between a polishing pad and the organic polymer-based ophthalmic substrate, and polishing the organic polymer-based ophthalmic substrate with the polishing pad and the aqueous polishing slurry to remove a surface portion of the organic polymer-based ophthalmic substrate.

The following examples are intended only to illustrate the invention and should not be construed as imposing limitations upon the claims.

### EXAMPLES

In the following examples, unless otherwise stated, the term “Diatomaceous Earth” refers to particles of diatomaceous earth having a D₅₀ of about 9.2 μm (about 1.5% residue on a 325 mesh). The term “Alumina” refers to calcined aluminum oxide having an average particle size of about 1.0 μm to about 2.5μm. The term “Aluminum Hydroxide” refers to colloidal aluminum hydroxide (˜90 nm Boehmite) dispersed in water, but is reported in the tables as a dry weight equivalent. The term “Aluminum Nitrate” refers to a solution of aluminum nitrate dissolved in water, but is reported in the tables as a dry weight equivalent. The term “PVP” refers to a polyvinyl pyrrolidone polymer having a weight average molecular weight of about 8,000.

The organic polymer-based ophthalmic substrates tested in the following examples are referred to by their refractive index. The specific compositions of the organic polymer-based ophthalmic substrates are regarded as proprietary by the manufacturers, and are not known by applicant. The term “1.498 Index” refers to an organic polymer-based ophthalmic substrate (believed to comprise an allyl diglycol carbonate polymer), which can be obtained from Essilor of America, Inc. of Petersburg, Florida as CR-39. The term “1.586 Index” refers to an organic polymer-based ophthalmic substrate (believed to comprise a polycarbonate polymer), which can also be obtained from Essilor of America, Inc.

### Example 1

Slurries 1A through 1D were each separately formed by adding the Components in the amounts shown in weight percent in Table 1 below to deionized water and mixing with overhead stirrers at room temperature (˜22.5° C.). After the slurries were formulated, measurements of the pH and the viscosity were made. The pH and viscosity data is reported in Table 1 below. A fresh amount of each slurry formulation was used to polish the organic polymer-based ophthalmic substrates listed in the “REMOVAL RATE” section of Table 1. The organic polymer-based ophthalmic substrates were separately polished on a Coburn 5056 Optical Polisher equipped with a bowl type slurry reservoir. The polishing pad was a SHAWSHEEN 349-7 Premium Grade Yellow Polishing Pad obtained from PSI of Odessa, Fla. The Optical Polisher machine settings were 20.0 psi pressure and 742 RPM. The slurry reservoir was equipped with a small recirculating pump. The slurry reservoir was charged with a fresh two thousand gram supply of slurry for each polishing test. The slurry was recirculated at a flow rate of 4.54 liters/minute. The slurry was chilled throughout each polishing experiment to a temperature range of 10 to 15° C. The substrates were not fined between polishing cycles. Polishing efficiency was determined by measuring the weight loss of each substrate after each polishing cycle and is reported in Table 1 as weight loss in milligrams per 6-minute cycle. The weight loss values reported in Table 1 were obtained via polishing each substrate three times, and then averaging the weight loss for the three polishing cycles.

TABLE 1

| | Slurry 1A | Slurry 1B | Slurry 1C | Slurry 1D |
|---|---|---|---|---|
| COMPONENTS: | | | | |
| Diatomaceous Earth | — | 8.0 | — | 8.0 |
| Alumina | 16.0 | — | 16.0 | — |
| Aluminum Nitrate | — | — | 3.3 | 2.0 |
| Deionized Water | 84.0 | 92.0 | 81.7 | 90.0 |
| PHYSICAL DATA: | | | | |
| pH | 10.0 | 10.0 | 3.7 | 4.0 |
| Viscosity (cPs) | 51.1 | 4.2 | 4.4 | 2.8 |
| REMOVAL RATE: | | | | |
| 1.498 Index | 186 | 183 | 235 | 284 |
| (mg/6 min) | | | | |
| 1.586 Index | 60 | 83 | 78 | 95 |
| (mg/6 min) | | | | |

Slurries 1B and 1D, which included 8.0% by weight of diatomaceous earth, exhibited an increased polishing efficiency as compared to Slurries 1A and 1C, which contained twice the loading of alumina. Slurry 1D shows that the addition of a known polishing rate accelerator for use with alumina abrasives, namely aluminum nitrate, also improves the polishing efficiency for diatomaceous earth containing slurry compositions.

### Example 2

Slurries 2A and 2B were each separately formed by mixing together the amounts of the Components shown in weight percent in Table 2 in the manner described in Example 1. After the slurries were formulated, measurements of the pH and the viscosity were made, and the data is reported in Table 2 below. A fresh amount of each slurry formulation was used to polish the organic polymer-based ophthalmic substrates using the same procedures and polishing equipment as described in Example 1. The polishing rate removal efficiency is reported in Table 2 below:

TABLE 2

| | Slurry 2A | Slurry 2B |
|---|---|---|
| COMPONENTS: | | |
| Diatomaceous Earth | — | 8.0 |
| Alumina | 12.0 | 12.0 |
| PVP | 0.5 | 0.5 |
| Aluminum Nitrate | 3.3 | 3.3 |
| Aluminum Hydroxide | 3.5 | 3.5 |
| Deionized Water | 80.7 | 72.7 |
| PHYSICAL DATA: | | |
| pH | 3.7 | 3.7 |
| Viscosity (cPs) | 5.5 | 19.8 |
| REMOVAL RATE: | | |
| 1.498 Index | 237 | 266 |
| (mg/6 min) | | |
| 1.586 Index | 91 | 152 |
| (mg/6 min) | | |

The presence of diatomaceous earth in Slurry 2B produced a significant increase in polishing efficiency for both 1.498 Index and 1.586 Index substrates.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed:

1. A method of polishing an organic polymer-based ophthalmic substrate comprising:
dispersing particles of diatomaceous earth in water to form an aqueous polishing slurry having a viscosity of less than about 200 cP;
disposing the aqueous polishing slurry between a polishing pad and the organic polymer-based ophthalmic substrate; and
polishing the organic polymer-based ophthalmic substrate with the polishing pad and the aqueous polishing slurry to remove a surface portion of the organic polymer-based ophthalmic substrate.

2. The method according to claim 1 wherein the organic polymer-based ophthalmic substrate is a high index organic polymer-based ophthalmic substrate.

3. The method according to claim 1 wherein the particles of diatomaceous earth have a D₅₀ of less than 10 μm.

4. The method according to claim 1 wherein the composition further comprises a plurality of particles of at least one selected from the group consisting of cerium oxide, aluminum oxide, zirconium oxide, tin oxide, silicon dioxide and titanium oxide.

5. The method according to claim 4, wherein the plurality of particles has a particle size within the range of from about 0.01 μm to about 4.0 μm.

6. The method according to claim 4, wherein the plurality of particles has a particle size within the range of from about 0.05 μm to about 2.5 μm.

7. The method according to claim 1 wherein the composition further comprises a water soluble nitrogen-containing organic polymer compound having a weight average molecular weight of from about 3,000 to about 60,000.

8. The method according to claim 7 wherein the water soluble nitrogen-containing organic polymer compound having a weight average molecular weight of from about 10,000 to about 50,000.

9. The method according to claim 7 wherein the water soluble nitrogen-containing organic polymer compound is selected from the group consisting of N-octyl-2-pyrrolidone, N-dodecyl-2-pyrrolidone, N-methyl-2-pyrrolidone, N-ethyl-2-pyrrolidone, N-hydroxyethyl-2-pyrrolidone, N-cyclohexyl-2-pyrrolidone, N-butyl-2-pyrrolidone, N-hexyl-2-pyrrolidone, N-decyl-2-pyrrolidone, N-octadecyl-2-pyrrolidone, N-hexadecyl-2-pyrrolidone, copolymers of polyvinyl pyrrolidone, polyvinyl caprolactam, and combinations thereof.

10. The method according to claim 1 wherein the composition is in the form of a dry powder before it is dispersed in water.

11. The method according to claim 1 wherein the composition is in the form of a viscous aqueous paste before it is dispersed in water so as to have a viscosity of less than about 100 cP.

12. The method according to claim 1 wherein the composition is in the form of a viscous aqueous paste before it is dispersed in water so as to have a viscosity of less than about 40 cP.

13. The method according to claim 1 wherein the particles of diatomaceous earth and any other abrasive particles present in the aqueous polishing slurry collectively comprise from about 5% to about 40% of the aqueous polishing slurry by weight.

14. The method according to claim 1 wherein the water soluble nitrogen-containing organic polymer is present in the aqueous polishing slurry at a loading up to about 5% by weight.

15. The method according to claim 1 wherein the dry powder composition further comprises aluminum nitrate.

16. The method according to claim 15 wherein the aluminum nitrate is present in an amount within the range of from about 0.25% to about 4.0% by weight.

17. The method according to claim 1 further comprising alumina particles and colloidal aluminum hydroxide.

18. The method according to claim 1 further comprising an anti-foaming agent.

19. The method according to claim 18, wherein the anti-foaming agent is siloxane treated fumed silica.

20. The method according to claim 1, wherein the organic polymer-based ophthalmic substrate has an index of refraction of at least 1.498.
